(19) United States
(12) Patent Application Publication
(10) Pub. No.: US 2005/0214336 A1
(43) Pub. Date: Sep. 29, 2005

(54) Parasite control in animals

(76) Inventors: Andreas Turberg, Haan (DE); Olaf Hansen, Langenfeld (DE); Venkata-Rangarao Kanikanti, Leverkusen (DE); Reinhold Lohr, Gladbach (DE); Dirk Mertin, Langenfeld (DE); Kirkor Sirinyan, Gladbach (DE)

Correspondence Address: Richard S Bullitt;Bayer Corporation, 36 Columbia Road, Box 1910, Morristown, NJ, 07962-1910, US

(21) Appl. No.: 10/511,403

(22) PCT Filed: Apr. 3, 2003
(86) PCT No.: PCT/EP03/03477

§ 371 Date: Jun. 6, 2005

(30) Foreign Application Priority Data
Apr. 16, 2002 (DE) 10216737.0

(51) Int. Cl. A01N 43/08; A01N 25/00

(52) U.S. Cl. 424/405; 514/473

(57) ABSTRACT

The present invention relates to the systemic and nonsystemic control of parasites in animals using phenylketoenol derivatives.

The present invention relates to the systemic and nonsystemic control of parasites in animals using phenylketoenol derivatives.

Phenylketoenols are known compounds. It is also known that these ketoenols possess outstanding insecticidal, acaricidal, herbicidal and fungicidal activity (EP-A-0528156, WO 98/05638 and WO 97/01535).

Surprisingly, it has now been found that certain phenylketoenol derivatives are particularly suitable for systemic and nonsystemic control of parasites such as fleas, lice or flies on animals and in the environment.

Owing to their activity regarding developmental stages and egg fertility, these compounds are not necessarily suitable as arthropodicidal agents in the veterinary field. Surprisingly, the selected compounds, when combined with certain application forms, were found to have biological activities against relevant ectoparasites and hygiene pests. Thus, the compounds described are particularly suitable for use against one-host tick species, lice and mites on livestock, for controlling stable flies, for example by the feed-through method, and for controlling flea, mite and tick populations in pet keeping. The control also extends to resistant species.

The invention relates to the use of phenylketoenol derivatives of the general formula (I), 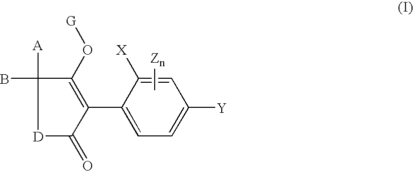
in which
X represents alkyl, halogen, alkoxy or haloalkyl,
Y represents hydrogen, alkyl, halogen, alkoxy, haloalkyl,
Z represents alkyl, halogen alkoxy,
n represents a number from 0 to 3 or where the radicals X and Z together with the phenyl radical to which they are bonded form the naphthalene radical of the formula 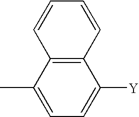
   in which Y has the abovementioned meaning,
G represents hydrogen (a) or the groups 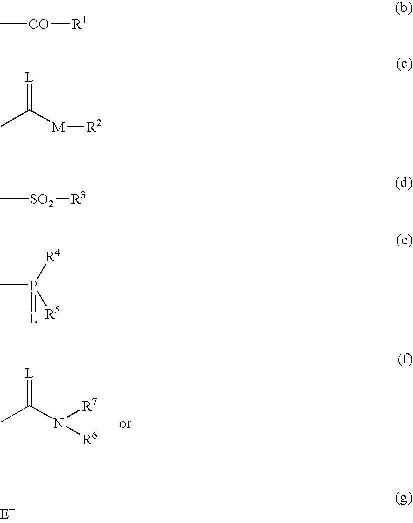
A and B can be identical or different and represent hydrogen, optionally halogen-substituted alkyl, alkenyl, alkynyl, alkoxyalkyl, alkylthioalkyl, or represent cycloalkyl which is optionally interrupted by hetero atoms, or represent aryl, aralkyl or hetaryl, each of which is optionally substituted by halogen, alkyl, haloalkyl, alkoxy, haloalkoxy, nitro,
   or where
A and B together with the carbon atom to which they are bonded form a saturated or unsaturated cycle which is optionally interrupted by hetero atoms and optionally substituted,
D represents oxygen, sulfur or —NH—,
E⁺ represents a metal ion equivalent or an ammonium ion,
L and M represents oxygen and/or sulfur,
R¹ represents optionally halogen-substituted alkyl, alkenyl, alkoxyalkyl, alkylthioalkyl, polyalkoxyalkyl or cycloalkyl, which can be interrupted by hetero atoms, or represents optionally substituted phenyl, optionally substituted phenylalkyl, substituted hetaryl, substituted phenoxyalkyl or substituted hetaryloxyalkyl and
R² represents optionally halogen-substituted alkyl, alkenyl, alkoxyalkyl, polyalkoxyalkyl, or optionally substituted phenyl or benzyl,
R³, R⁴ and R⁵ independently of one another represent optionally halogen-substituted alkyl, alkoxy, alkylamino, dialkylamino, alkylthio, alkenylthio, alkynylthio, cycloalkylthio and optionally substituted phenyl, phenoxy or phenylthio,
R⁶ and R⁷ independently of one another represent hydrogen, optionally halogen-substituted alkyl, alkenyl, alkoxy, alkoxyalkyl, or represent optionally substituted phenyl, or represent optionally substituted benzyl,
or where R⁶ and R⁷ together represent an alkylene radical which is optionally interrupted by oxygen,
with the exception of the following compounds:
3-(2-methoxyphenyl)-4-hydoxy-Δ³-dihydrofuran-2-one,
3-(2-chlorophenyl)-4-hydoxy-Δ³-dihydrofuran-3-2-one,
3-(2-methoxyphenyl)-4-hydoxy-Δ³-dihydrofuran-2-one,
3-(2-fluorophenyl)-4-hydoxy-Δ³-dihydrofuran-2-one,
and the enantiomerically pure forms of compounds of the formula (I),
for the preparation of medicaments for controlling parasites in animals and in their environment.

Including the various meanings (a), (b), (c), (d), (e), (f) and (g) of group G of the general formula (I), the following main structures (Ia) to (Ig) result: 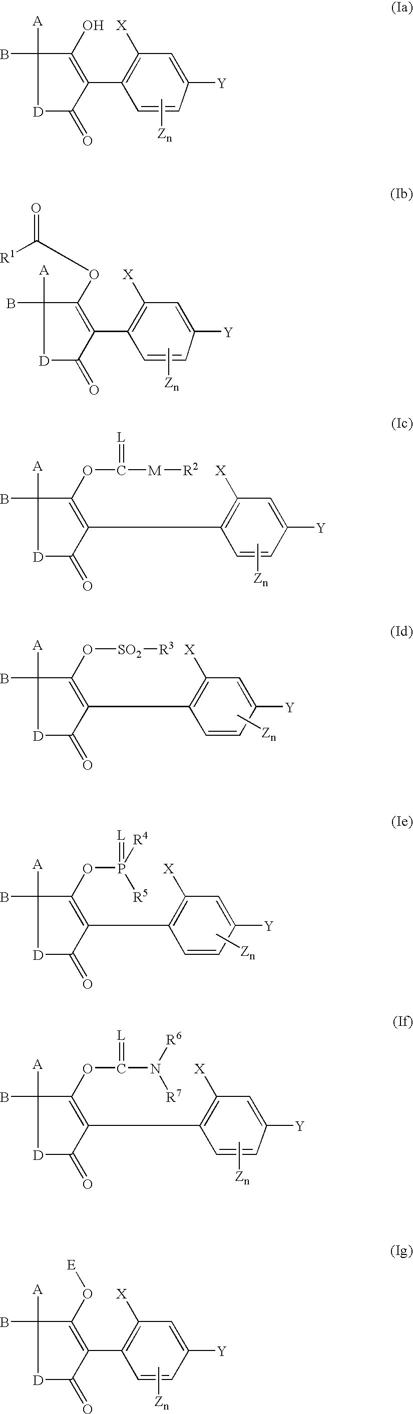
where
A, B, D, E, L, M, X, Y, Zₙ, R¹, R², R³, R⁴, R⁵, R⁶ and R⁷ have the abovementioned meanings.

Compounds of the formula (I) or of the formulae (Ia) to (Ig), respectively, and their preparation are extensively described in EP-A-0 528 156, WO 98/05638 and WO 97/01535.

Compounds of the formula (I) which are preferably used are those

in which

X represents C₁-C₆-alkyl, halogen, C₁-C₆-alkoxy or C₁-C₃-haloalkyl,
Y represents hydrogen, C₁-C₆-alkyl, halogen, C₁-C₆-alkoxy, C₁-C₃-haloalkyl,
Z represents C₁-C₆-alkyl, halogen, C₁-C₆-alkoxy,
n represents a number from 0 to 3,
or where the radicals X and Z together with the phenyl radical to which they are bonded form the naphthalene radical of the formula 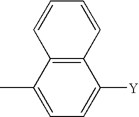
   in which Y has the abovementioned meaning,
A and B are identical or different and represents hydrogen or optionally halogen-substituted straight-chain or branched C₁-C₁₂-alkyl, C₃-C₈-alkenyl, C₃-C₈-alkynyl, C₁-C₁₀-alkoxy-C₂-C₈-alkyl, C₁-C8-polyalkoxy-C₂-C₈-alkyl, C₁-C₁₀-alkylthio-C₂-C₈-alkyl, cycloalkyl having 3 to 8 ring atoms which can be interrupted by oxygen and/or sulfur, or represents aryl, hetaryl or aryl-C₁-C₆-alkyl, each of which is optionally substituted by halogen, C₁-C₆-alkyl, C₁-C₆-haloalkyl, C₁-C₆-alkoxy, C₁-C₆-haloalkoxy,
or where
A and B together with the carbon atom to which they are bonded form a saturated or unsaturated 3- to 8-membered ring which is optionally interrupted by oxygen and/or sulfur and optionally substituted by halogen, C₁-C₆-alkyl, C₅-C₆-alkoxy, C₁-C₄-haloalkyl, C₁-C₄-haloalkoxy, C₁-C₄-alkylthio or optionally substituted aryl,
G represents hydrogen (a) or the groups 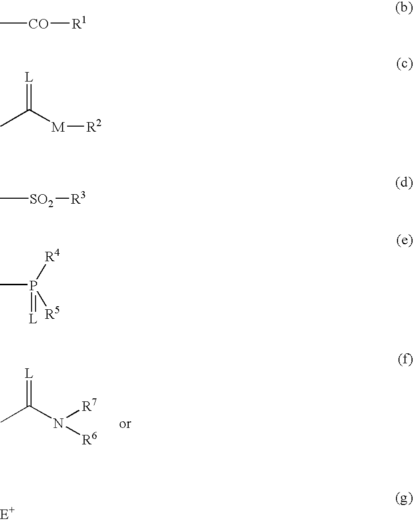
   in which
E⁺ represents a metal ion equivalent or an ammonium ion,
L and M represents oxygen and/or sulfur,
R¹ represents optionally halogen-substituted C₁-C₂₀-alkyl, C₂-C₂₀-alkenyl, C₁-C₈-alkoxy-C₂-C₈-alkyl, C₁-C₈-alkylthio-C₂-C₈-alkyl, C₁-C₈-polyalkoxy-C₂-C₈-alkyl or cycloalkyl which have 3 to 8 ring atoms and which can be interrupted by oxygen and/or sulfur atoms,
   or represents phenyl which is optionally substituted by halogen, nitro, C₁-C₆-alkyl, C₁-C₆-alkoxy, C₁-C₆-haloalkyl, C₁-C₆-haloalkoxy,
   or represents phenyl-C₁-C₆-alkyl which is optionally substituted by halogen, C₁-C₆-alkyl, C₁-C₆-alkoxy, C₁-C₆-haloalkyl, C₁-C₆-haloalkoxy,
   or represents hetaryl which is optionally substituted by halogen and/or C₁-C₆-alkyl,
   or represents phenoxy-C₁-C₆-alkyl which is optionally substituted by halogen and C₁-C₆-alkyl,
   or represents hetaryloxy-C₁-C₆-alkyl which is optionally substituted by halogen, amino and C₁-C₆-alkyl,
R² represents optionally halogen-substituted C₁-C₂₀-alkyl, C₁-C₂₀-alkenyl, C₁-C₈-alkoxy-C₂-C₈-alkyl, C₁-C₈-polyalkoxy-C₂-C₈-alkyl,
   or represents phenyl or benzyl, each of which is optionally substituted by halogen, nitro, C₁-C₆-alkyl, C₁-C₆-alkoxy, C₁-C₆-haloalkyl,
R³, R⁴ and R⁵ independently of one another represent optionally halogen-substituted C₁-C₈-alkyl, C₁-C₈-alkoxy, C₁-C₈-alkylamino, di(C₁-C₈-)-alkylamino, C₁-C₈-alkylthio, C₂-C₅-alkenylthio, C₂-C₅-alkynylthio, C₃-C₇-cycloalkylthio, or represent phenyl, phenoxy or phenylthio, each of which is optionally substituted by halogen, nitro, cyano, C₁-C₄-alkoxy, C₁-C₄-haloalkoxy, C₁-C₄-alkylthio, C₁-C₄-haloalkylthio, C₁-C₄-alkyl, C₁-C₄-haloalkyl,
R⁶ and R⁷ independently of one another represents hydrogen, optionally halogen-substituted C₁-C₂₀-alkyl, C₁-C₂₀-alkoxy, C₂-C₈-alkenyl, C₁-C₂₀-alkoxy-C₁-C₂₀-alkyl, or represents phenyl which is optionally substituted by halogen, C₁-C₂₀-haloalkyl, C₁-C₂₀-alkyl or C₁-C₂₀-alkoxy, or represents benzyl which is optionally substituted by halogen, C₁-C₂₀-alkyl, C₁-C₂₀-haloalkyl or C₁-C₂₀-alkoxy, or together represent a C₂-C6-alkylene ring which is optionally interrupted by oxygen,
with the exception of the following compounds:
3-(2-methoxyphenyl)-4-hydoxy-Δ³-dihydrofuran-2-one,
3-(2-chlorophenyl)-4-hydoxy-Δ³-dihydrofuran-2-one,
3-(2-methoxyphenyl)-4-hydoxy-Δ³-dihydrofuran-2-one,
3-(2-fluorophenyl)-4-hydoxy-Δ³-dihydrofuran-2-one,
and the enantiomerically pure forms of compounds of the formula (I).

Compounds of the formula (I) which are especially preferably employed are those in which
X represents C₁-C₆-alkyl, halogen, C₁-C₆-alkoxy or C₁-C₂-haloalkyl,
Y represents hydrogen, C₁-C₆-alkyl, halogen, C₁-C₆-alkoxy, C₁-C₂-haloalkyl,
Z represents C₁-C₄-alkyl, halogen, C₁-C₄-alkoxy,
n represents a number from 0 to 3,
   or where the radicals X and Z together with the phenyl radical to which they are bonded form the naphthalene radical of the formula 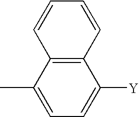
      in which Y has the abovementioned meaning,
A and B are identical or different and represents hydrogen, optionally halogen-substituted straight-chain or branched C₁-C₁₀-alkyl, C₃-C₆-alkenyl, C₃-C₆-alkynyl, C₁-C₈-alkoxy-C₂-C₆-alkyl, C₁-C₆-polyalkoxy-C₂-C₆-alkyl, C₁-C₈-alkylthio-C₂-C₆-alkyl, cycloalkyl which has 3 to 7 ring atoms and which can be interrupted by 1 to 2 oxygen and/or sulfur atoms, or represents aryl, hetaryl or aryl-C₁-C₄-alkyl, each of which is optionally substituted by halogen, C₁-C₄-alkyl, C₁-C₄-haloalkyl, C₁-C₄-alkoxy, nitro,
   or where
A and B together with the carbon atom to which they are bonded form a saturated or unsaturated 3- to 8-membered ring which is optionally interrupted by oxygen and/or sulfur and optionally substituted by halogen, C₁-C₅-alkyl, C₁-C₅-alkoxy, C₁-C₃-haloalkyl, C₁-C₄-haloalkoxy, C₁-C₃-alkylthio or optionally halogen-, alkyl-, alkoxy-substituted aryl,
G represents hydrogen (a) or the groups 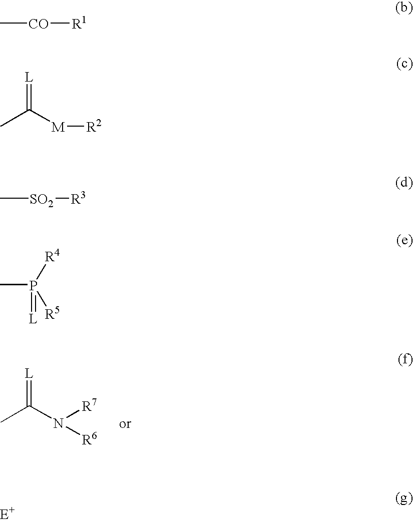
   in which
E⁺ represents a metal ion equivalent or an ammonium ion,
L and M are in each case oxygen and/or sulfur,
R¹ represents optionally halogen-substituted C₁-C₁₆ -alkyl, C₂-C₁₆-alkenyl, C₁-C₆-alkoxy-C₂-C₆-alkyl, C₁-C₁₆-alkylthio-C₂-C₆-allyl, C₁-C₆-polyalkoxy-C₂-C₆-alkyl or cycloalkyl which has 3 to 7 ring atoms and which can be interrupted by 1 to 2 oxygen and/or sulfur atoms,
   or represents phenyl which is optionally substituted by halogen, nitro, C₁-C₄-alkyl, C₁-C₄-alkoxy, C₁-C₃-haloalkyl, C₁-C₃-haloalkoxy,
   or represents phenyl-C₁-C₄-alkyl which is optionally substituted by halogen, C₁-C₄-alkyl, C₁-C₄-alkoxy, C₁-C₃-haloalkyl, C₁-C₃-haloalkoxy,
   or represents hetaryl which is optionally substituted by halogen and/or C₁-C₆-alkyl,
   or represents phenoxy-C₁-C₅-alkyl which is optionally substituted by halogen and C₁-C₄-alkyl,
   or represents hetaryloxy C₁-C₅-alkyl which is optionally substituted by halogen, amino and C₁-C₄-alkyl,
R² represents optionally halogen-substituted C₁-C₁₆-alkyl, C₂-C₁₆-alkenyl, C₂-C₁₆-alkoxy-C₂-C₆-alkyl, C₁-C₆-polyalkoxy-C₂-C₆-alkyl,
   or represents phenyl or benzyl, each of which is optionally substituted by halogen, nitro, C₁-C₄-alkyl, C₁-C₃-alkoxy, C₁-C₃-haloalkyl,
R³, R⁴ and R⁵ independently of one another represent optionally halogen-substituted C₁-C₆-alkyl, C₁-C₆-alkoxy, C₁-C₆-alkylamino, di(C₁-C₆-)-alkylamino, C₁-C₆-alkylthio, C₃-C₄-alkenylthio, C₂-C₄-alkynylthio, C₃-C₆-cycloalkylthio, or represent phenyl, phenoxy or phenylthio, each of which is optionally substituted by fluorine, chlorine, bromine, nitro, cyano, C₁-C₃-alkoxy, C₁-C₃-haloalkoxy, C₁-C₃-alkylthio, C₁-C₃-haloalkylthio, C₁-C₃-alkyl, C₁-C₃-haloalkyl,
R⁶ and R⁷ independently of one another represents hydrogen, optionally halogen-substituted C₁-C₂₀-alkyl, C₁-C₂₀-alkoxy, C₂-C₈-alkenyl, C₁-C₂₀-alkoxy-C₁-C₂₀-alkyl, or represents phenyl which is optionally substituted by halogen, C₁-C₅-haloalkyl, C₁-C₅-alkyl or C₁-C₅-alkoxy, or represents benzyl which is optionally substituted by halogen, C₁-C₅-alkyl, C₁-C₅-halo-alkyl or C₁-C₅-alkoxy,
with the exception of the following compounds:
3-(2-methoxyphenyl)-4-hydoxy-Δ³-dihydrofuran-2-one,
3-(2-chlorophenyl)-4-hydoxy-Δ³-dihydrofuran-2-one,
3-(2-methoxyphenyl)-4-hydoxy-Δ³-dihydrofuran-2-one,
3-(2-fluorophenyl)-4-hydoxy-Δ³-dihydrofuran-2-one,
and the enantiomerically pure forms of compounds of the formula (I).

Very especially preferred compounds of the formula (I) are those

in which

X represents methyl, ethyl, propyl, i-propyl, fluorine, chlorine, bromine, methoxy, ethoxy and trifluoromethyl,
Y represents hydrogen, methyl, ethyl, propyl, i-propyl, butyl, i-butyl, tert-butyl, fluorine, chlorine, bromine, methoxy, ethoxy and trifluoromethyl,
Z represents methyl, ethyl, i-propyl, butyl, i-butyl, tert-butyl, fluorine, chlorine, bromine, methoxy and ethoxy,
n represents a number from 0 to 3,
   or where the radicals X and Z together with the phenyl radical to which they are bonded form the radical of formula 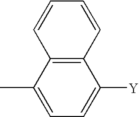
      in which Y has the abovementioned meaning,
A and B are identical or different and represent hydrogen, optionally halogen-substituted straight-chain or branched C₁-C₈-alkyl, C₃-C₄-alkenyl, C₃-C₄-alkynyl, C₁-C₆-alkoxy-C₂-C₄-alkyl, C₁-C₄-polyalkoxy-C₂-C₄-alkyl, C₁-C₆-alkylthio-C₂-C₄-alkyl, cycloalkyl which has 3 to 6 ring atoms and which can be interrupted by 1 to 2 oxygen and/or sulfur atoms, or represent optionally fluorine-, chlorine-, methyl-, ethyl-, propyl-, isopropyl-, methoxy-, ethoxy-, trifluoromethyl-, nitro-substituted aryl, pyridine, imidazole, pyrazole, triazole, indole, thiazole or aryl-C₁-C₃-alkyl,
or where
A and B together with the carbon atom to which they are bonded form a saturated or unsaturated 3- to 8-membered ring which is optionally interrupted by oxygen and/or sulfur and optionally substituted by fluorine, chlorine, C₁-C₄-alkyl, C₁-C₄-alkoxy, trifluoromethyl, C₁-C₂-alkylthio or optionally fluorine-, chlorine-, methyl-, methoxy-substituted aryl,
G represents hydrogen (a) or the groups 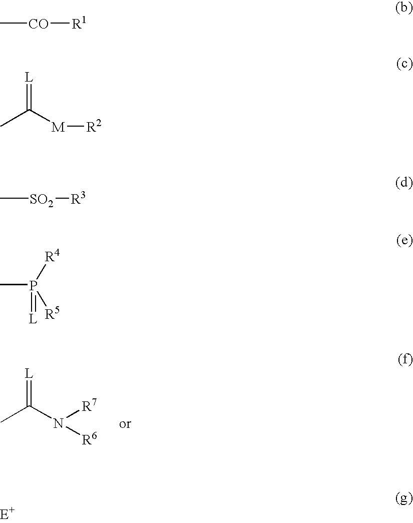
   in which
E⁺ represents a metal ion equivalent or an ammonium ion,
L and M are in each case oxygen and/or sulfur,
R¹ represents optionally fluorine- or chlorine-substituted C₁-C₁₄-alkyl, C₁-C₁₄-alkyl, C₂-C₁₄-alkenyl, C₁-C₄-alkoxy-C₂-C₆-alkyl, C₁-C₄-alkylthio-C₂-C₆-alkyl, C₁-C₄-polyalkoxy-C₂-C₄-alkyl and cycloalkyl which has 3 to 6 ring atoms and which can be interrupted by 1 to 2 oxygen and/or sulfur atoms,
   or represents phenyl which is optionally substituted by fluorine, chlorine, bromine, methyl, ethyl, propyl, i-propyl, methoxy, ethoxy, trifluoromethyl, trifluoromethoxy, nitro,
   or represents phenyl-C₁-C₃-alkyl which is optionally substituted by fluorine, chlorine, bromine, methyl, ethyl, propyl, i-propyl, methoxy, ethoxy, trifluoromethyl, trifluoromethoxy,
   or represents pyridyl, pyrimidyl, thiazolyl and pyrazolyl each of which is optionally substituted by fluorine, chlorine, bromine, methyl, ethyl, or represents phenoxy-C₁-C₄-alkyl which is optionally substituted by fluorine, chlorine, methyl, ethyl,
   or represents pyridyloxy-C₁-C₄-alkyl, pyrimidyloxy-C₁-C₄-alkyl and thiazolyloxy-C₁-C₅-alkyl, each of which is optionally substituted by fluorine, chlorine, amino, methyl, ethyl,
R² represents optionally fluorine- or chlorine-substituted C₁-C₁₄-alkyl, C₂-C₁₄-alkenyl, C₁-C₄-alkoxy-C₂-C₆-alkyl, C₁-C₄-polyalkoxy-C₂-C₆-alkyl,
   or represents phenyl or benzyl, each of which is optionally substituted by fluorine, chlorine, nitro, methyl, ethyl, propyl, i-propyl, methoxy, ethoxy, trifluoromethyl,
R³, R⁴ and R⁵ dependently of one another represent optionally fluorine- or chlorine-substituted C₁-C₄-alkyl, C₁-C₄-alkoxy, C₁-C₄-alkylamino, di-(C₁-C₄-alkyl)-amino, C₁-C₄-alkylthio, or represent phenyl, phenoxy or phenylthio, each of which is optionally substituted by fluorine, chlorine, bromine, nitro, cyano, C₁-C₂-alkoxy, C₁-C₄-fluoroalkoxy, C₁-C₂-chloroalkoxy, C₁-C₂-alkylthio, C₁-C₂-fluoroalkylthio, C₁-C₂-chloroalkylthio, C₁-C₃-alkyl,
R⁶ and R⁷ independently of one another represents C₁-C₁₀-alkyl, C₁-C₁₀-alkoxy, C₁-C₁₀-alkoxy-(C₁-C₁₀)-alkyl, each of which is optionally substituted by fluorine, chlorine, bromine, or represent phenyl which is optionally substituted by fluorine, chlorine, bromine, C₁-C₂₀-haloalkyl, C₁-C₂₀-alkyl or C₁-C₄-alkoxy, or represents benzyl which is optionally substituted by fluorine, chlorine, bromine, C₁-C₄-alkyl, C₁-C₄-haloalkyl or C₁-C₄-alkoxy,
with the exception of the following compounds:
3-(2-methoxyphenyl)-4-hydoxy-Δ³-dihydrofuran-2-one,
3-(2-chlorophenyl)-4-hydoxy-Δ³-dihydrofuran-2-one,
3-(2-methoxyphenyl)-4-hydoxy-Δ³-dihydrofuran-2-one,
3-(2-fluorophenyl)-4-hydoxy-Δ³-dihydrofuran-2-one,
and the enantiomerically pure forms of compounds of the formula (I).

In accordance with a preferred embodiment of the present invention, dihydrofuranone derivative, i.e. compounds of the formula (I) in which D represents oxygen, are employed. The other substituents can assume the meanings indicated above.

In accordance with a further preferred embodiment of the present invention, pyrrolidinedione derivatives, i.e. compounds of the formula (I) in which D represents —NH—, are employed. The other substituents can assume the meanings indicated above.

The following individual compounds which can especially preferably be used may be referred to expressly:
compounds of the formula (Ia) which are mentioned in Table 1 of EP-A-528 156.
compounds of the formula (Ib) which are mentioned in Table 2 of EP-A-528 156.
compounds of the formula (Ic) which are mentioned in Table 3 of EP-A-528 156.
compounds of the formula (Id) which are mentioned in Table 4 of EP-A-528 156.
compounds of the formula (Ie) which are mentioned in Table 5 of EP-A-528 156.
compounds of the formula (If) which are mentioned in Table 6 of EP-A-528 156.
compounds of the formula (Ig) which are mentioned in Table 7 of EP-A-528 156.

Further individual compounds of the formulae (Ia), (Ib), (Ic), (Id), (Ie) and (Ig) which can especially preferably be used are those which are mentioned as preparation examples in EP-A-528 156.

Further compounds of the type I-1-c, which are disclosed in WO98/05638, in particular the examples I-1-c-1 to I-1-c-21, may be mentioned as compounds which can especially preferably be used.

Further compounds of the type I-1-c, which are disclosed in WO97/01535, in particular the examples I-1-c-1 to I-1-c-9, may be mentioned as compounds which can especially preferably be used.

Very especially preferred compounds for the use according to the invention are the two compounds A to D which follow:

### A: 2,2-dimethyl-, 3-(2,4-dichlorophenyl)-2-oxo-1-oxaspiro[4,5]dec-3-en-4-yl-butanoate:

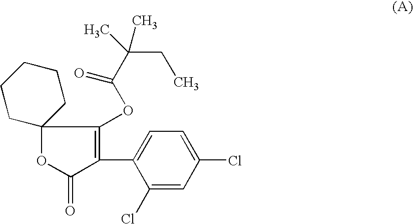

### B: 2-oxo-3-(2,4,6-trimethylphenyl)-1-oxaspiro[4,4]non-3-en-4-yl-3,3-dimethyl-butanoate:

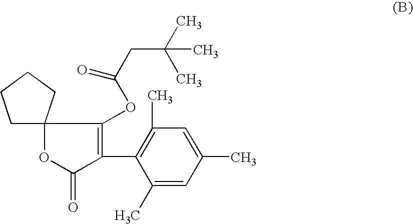

### C: 3-(2,5-dimethylphenyl)-8-methoxy-2-oxo-1-azaspiro[4.5]dec-3-en-4-yl-ethyl-carbonate

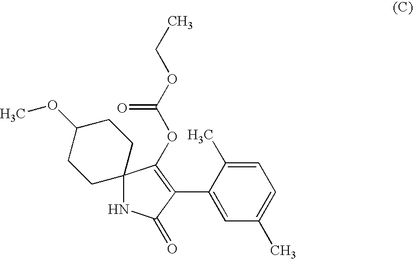

### D: 3-(4-chloro-2,5-dimethylphenyl)-8-methoxy-2-oxo-1-azaspiro[4.5]dec-3-en-4-yl-ethyl-carbonate

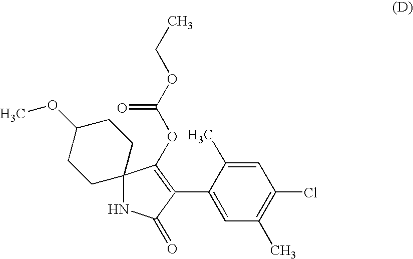

The abovementioned active compounds are suitable for the systemic and/or nonsystemic control of parasites which are found in animal keeping and animal breeding in domestic animals and livestock, but also in zoo animals, laboratory animals, experimental animals and pets, and have favorable toxicity to warm-blooded species. In this context, they are active against all or individual developmental stages of the pests, and against resistant and normally-sensitive species of the pests.

Parasites are, in particular, arthropods. The preparations according to the invention are preferably employed for controlling ectoparasites.

The abovementioned ectoparasites include: hard ticks, soft ticks, mange mites, harvest mites, flies (stinging and licking), parasitic fly larvae, lice, hair lice, bird lice and fleas.

These parasites include:

From the order of the Anoplurida, for example, Haematopinus spp., Linognathus spp., Pediculus spp., Phtirus spp., Solenopotes spp.

From the order of the Mallophagida and the suborders Amblycerina and Ischnocerina, for example Trimenopon spp., Menopon spp., Trinoton spp., Bovicola spp., Wemeckiella spp., Lepikentron spp., Trichodectes spp., Felicola spp.

From the order Diptera and the suborders Nematocerina and Brachycerina, for example Aedes spp., Anopheles spp., Culex spp., Simulium spp., Eusimulium spp., Phlebotomus spp., Lutzomyia spp., Culicoides spp., Chrysops spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp., Melophagus spp.

From the order of the Siphonapterida, for example Pulex spp., Ctenocephalides spp., Xenopsylla spp., Ceratophyllus spp.

From the order of the Heteropterida, for example Cimex spp., Triatoma spp., Rhodnius spp., Panstrongylus spp.

From the order of the Blattarida, for example Blatta orientalis, Periplaneta americana, Blattella germanica, Supella spp.

From the subclass of the Acaria (Acarida) and the orders of the Meta- and Mesostigmata, for example Argas spp., Omithodorus spp., Otobius spp., Ixodes spp., Amblyomrnia spp., Boophilus spp., Dermacentor spp., Haemophysalis spp., Hyalomma spp., Rhipicephalus spp., Dermanyssus spp., Raillietia spp., Pneumonyssus spp., Stemostoma spp., Varroa spp.

From the order of the Actinedida (Prostigmata) and Acaridida (Astigmata), for example Acarapis spp., Cheyletiella spp., Omithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., Laminosioptes spp.

The livestock and breeding animals include mammals such as, for example, cattle, horses, sheep, pigs, goats, camels, water buffalo, donkeys, rabbits, fallow deer, reindeer; fur bearers such as, for example, mink, chinchilla, racoon; for example chickens, geese, turkeys, ducks.

Laboratory animals and experimental animals include mice, rats, guinea pigs, golden hamsters, dogs and cats.

The pets include dogs and cats.

The application can be both prophylactic and therapeutic.

The active compounds for the systemic control of parasites are preferably applied directly or, in the form of suitable preparations, enterally, parenterally, dermally or nasally, in particular orally, transdermally, by means of pour-on/spot-on formulations, or in the form of an injection.

The active compounds are applied enterally, for example orally in the form of powders, tablets, capsules, pastes, drinks, granules, of solutions, suspensions and emulsions for oral administration, boluses, medicated feed or drinking water. They are applied dermally for example in the form of dipping, spraying, pouring-on or spotting-on. They are administered parenterally for example in the form of an injection (intramuscular, subcutaneous, intravenous, intraperitoneal) or by implants.

Solutions for injection are prepared by dissolving the active compound in a suitable solvent and, if appropriate, adding additives such as solubilizers, acids, bases, buffer salts, antioxidants, preservatives. The solutions are filter-sterilized and packaged.

Examples of solvents which may be mentioned are: physiologically acceptable solvents sulch as water, alcohols such as ethanol, butanol, benzyl alcohol, glycerol, propylene glycol, polyethylene glycols, N-methylpyrrolidone, and mixtures of these.

If appropriate, the active compounds can also be dissolved in physiologically acceptable vegetable or synthetic oils which are suitable for injection.

Solubilizers which may be mentioned are, for example, solvents which promote the dissolution of the active compound in the main solvent or which prevent its precipitation. Examples are polyvinylpyrrolidone, polyoxyethylated castor oil, polyoxyethylated sorbitan esters.

Examples of preservatives are: benzyl alcohol, trichlorobutanol, p-hydroxybenzoic esters, n-butanol.

Suitable preparations for oral administration which may be mentioned are, for example, tablets, homogeneous solutions, emulsions, suspensions.

Oral solutions are administered directly. Concentrates are first diluted to the use concentration and then administered orally. Oral solutions and concentrates are prepared as described above for the solutions for injection, but sterile procedures can be dispensed with.

Suitable preparations for transdermal application are, as is known, active-compound-comprising solutions which may comprise absorption accelerators. Examples of absorption accelerators are DMSO (dimethyl sulfoxide), DMF (dimethylformamide), triglycerides and long-chain aliphatic fatty acid esters, azones and their derivatives, terpenes and essential oils, amino acid derivatives.

Said preparations comprise the active compound in concentrations of from 0.1 to 65% by weight, preferably from 1.0 to 40% by weight.

For the systemic control of parasites on animals, it has generally proved advantageous to administer amounts of approximately from 0.5 to 100 mg of active compound/kg body weight in order to achieve a good effect.

Dermal administration is carried out for example in the form of bathing, dipping, spraying, pouring-on or spotting-on, washing, shampooing, drenching, dusting, or by means of solid preparations.

Suitable preparations are:
solutions or concentrates for administration after dilution, sprays, spot-on/pour-on solutions for direct application, pour-on/spot-on formulations, gels;
emulsions and suspensions for dermal administration and solid and semi-solid preparations;
formulations in which the active compound is incorporated in an ointment base or in an oil-in-water or water-in-oil emulsion base;
solutions for use on the skin are applied dropwise, spread on, rubbed in, splashed on, sprayed on, or applied by dipping, bathing or washing.

The solutions are prepared by dissolving the active compound in a suitable solvent and, if appropriate, adding additives such as solubilizers, acids, bases, buffer salts, antioxidants, preservatives.

Solvents which may be mentioned are: water, alkanols, glycols, polyethylene glycols, polypropylene glycols, glycerol, aromatic alcohols such as benzyl alcohol, phenyl-ethanol, phenoxyethanol, esters such as ethyl acetate, butyl acetate, benzyl benzoate, ethers such as alkylene glycol alkyl ethers such as dipropylene glycol monomethyl ether, diethylene glycol monobutyl ether, ketones such as acetone, methyl ethyl ketone, aromatic and/or aliphatic hydrocarbons, vegetable or synthetic oils, DMF, dimethyl-acetamide, N-methylpyrrolidone, 2-pyrrolidones, 2-dimethyl-4-oxymethylene-1,3-dioxolane, 2-(1-nonyl)-1,3-dioxolane, transcutol, solketal, propylene carbonate, propylene glycol diacetate, lactic acid.

If appropriate, the active compounds can also be dissolved in physiologically acceptable vegetable or synthetic oils.

Solubilizers which may be mentioned are, for example, solvents which promote the dissolution of the active compound in the main solvent or which prevent its precipitation. Examples are polyvinylpyrrolidone, polyoxyethylated castor oil, polyoxyethylated sorbitan esters.

Examples of preservatives are: benzyl alcohol, trichlorobutanol, p-hydroxybenzoic esters, n-butanol.

When preparing solutions, it may be advantageous to add thickeners. Thickeners are: inorganic thickeners such as bentonites, colloidal silica, aluminum monostearate, organic thickeners such as cellulose derivatives, polyvinyl alcohols and their copolymers, acrylates and methacrylates.

Gels which are applied to or spread onto onto the skin are prepared by treating solutions which have been prepared as described above with such an amount of thickener that a clear composition with an ointment-like consistency results. The thickeners are the thickeners stated further above.

Pour-on/spot-on formulations are poured on, spotted on or splashed onto limited areas of the skin, the active compound being distributed over the surface of the body. Pour-on/spot-on formulations where the active compound penetrates the skin and acts systemically are also feasible.

Pour-on/spot-on formulations are prepared by dissolving, suspending or emulsifying the active compound in, or into, suitable solvents or solvent mixtures which are tolerated by the skin. If appropriate, further adjuvants such as colorants, antioxidants, UV stabilizers, tackifiers are added. In the case of systemically acting pour-on/spot-on formulations, it is advantageous additionally to add absorption accelerators.

Colorants are all those colorants which are licensed for use in animals and which can be in dissolved or suspended form.

Other adjuvants are spreading oils such as isopropyl myristate, dipropylene glycol pelargonate, silicone oils, fatty acid esters, triglycerides, fatty alcohols.

Antioxidants are sulfites or metabisulfites such as potassium metabisulfite, ascorbic acid, butylhydroxytoluene, butylhydroxyanisole, tocopherol.

UV stabilizers are, for example, substances from the class of the benzophenones or novantisolic acid.

Examples of tackifiers are cellulose derivatives, starch derivatives, polyacrylates, natural polymers such as alginates, gelatin.

Examples of absorption accelerators are DMSO, spreading oils such as isopropyl myristate, dipropylene glycol pelargonate, silicone oils, fatty acid esters, triglycerides, fatty alcohols.

Emulsions can be applied orally, dermally or in the form of injections. They are either of the water-in-oil type or of the oil-in-water type.

They are prepared by dissolving the active compound either in the hydrophobic phase or in the hydrophilic phase and homogenizing this phase with the solvent of the other phase with the aid of suitable emulsifiers and, if appropriate, further adjuvants such as colorants, absorption accelerators, preservatives, antioxidants, UV stabilizers, viscosity-increasing substances.

The following may be mentioned as hydrophobic phase (oils): liquid paraffins, silicone oils, natural vegetable oils such as sesame seed oil, almond oil, castor oil, synthetic triglycerides such as caprylic/capric acid bigylceride, triglyceride mixture with vegetable fatty acids of chain length C₈₋₁₂ or other specifically selected natural fatty acids, partial glyceride mixtures of saturated or unsaturated, if appropriate also hydroxyl-containing, fatty acids, mono- and diglycerides of the C₈/C₁₀-fatty acids.

Fatty acid esters such as ethyl stearate, di-n-butyryl adipate, hexyl laurate, dipropylene glycol pelargonate, esters of a branched fatty acid of medium chain length with. saturated fatty alcohols of chain length C₁₆-C₁₈, isopropyl myristate, isopropyl palmitate, caprylicicapric esters of saturated fatty alcohols of chain length C₁₂-C₁₈, isopropyl stearate, oleyl oleate, decyl oleate, ethyl oleate, ethyl lactate, waxy fatty acid esters such as dibutyl phthalate, diisopropyl adipate, ester mixtures related to the latter, and other fatty alcohols such as isotridecyl alcohol, 2-octyldodecanol, cetyl stearyl alcohol, oleyl alcohol.

Fatty acids such as; for example, oleic acid and its mixtures.

The following may be mentioned as hydrophilic phase:
water, alcohols such as, for example, propylene glycol, glycerol, sorbitol and their mixtures.

The following may be mentioned as emulsifiers: nonionic surfactants, for example polyoxyethylated castor oil, polyoxyethylated sorbitan monooleate, sorbitan monostearate, glycerol monostearate, polyoxyethyl stearate, alkylphenyl polyglycol ethers; ampholytic surfactants such as disodium N-lauryl-β-iminodipropionate or lecithin;
anionic surfactants such as sodium lauryl sulfate, fatty alcohol ether sulfates, mono/dialkylpolyglycol ether orthophosphoric ester monoethanolamine salt; cationic surfactants such as cetyltrimethylammonium chloride.

Further adjuvants which may be mentioned are: viscosity-increasing and emulsion-stabilizing substances such as carboxymethylcellulose, methylcellulose and other cellulose and starch derivatives, polyacrylates, alginates, gelatin, gum arabic, polyvinyl-pyrrolidone, polyvinyl alcohol, copolymers of methyl vinyl ether and maleic anhydride, polyethylene glycols, waxes, colloidal silica, or mixtures of the abovementioned substances.

Suspensions can be administered orally, dermally or in the form of an injection. They are prepared by suspending the active compound in a carrier liquid, if appropriate using further auxiliaries such as wetting agents, colorants, absorption accelerators, preservatives, antioxidants or UV stabilizers.

Carrier liquids which may be mentioned are all homogeneous solvents and solvent mixtures.

Wetting agents (dispersants) which may be mentioned are those detailed further above.

Further adjuvants which may be mentioned are those detailed further above.

Semi-solid preparations can be administered orally or dermally. They only differ from the above-described suspensions and emulsions by their higher viscosity.

To prepare solid preparations, the active compound is mixed with suitable carriers, if appropriate using adjuvants, and shaped as desired.

Carriers which may be mentioned are all physiologically acceptable solid inert substances. These can be inorganic and organic substances. Examples of inorganic substances are sodium chloride, carbonates such as calcium carbonate, hydrogen carbonates, aluminum oxides, silicic acids, clays, precipitated or colloidal silicon dioxide, phosphates.

Adjuvants are preservatives, antioxidants, colorants which have already been mentioned furthere above.

Further suitable adjuvants are glidants and lubricants such as, for example, magnesium stearate, stearic acid, talc, bentonites.

Ready-to-use preparations comprise the active compound in concentrations of from 1 ppm-80 percent by weight, preferably from 0.01-65 percent by weight. Preferred active compound quantities are 1 to 50 percent by weight, especially preferably 5 to 40 percent by weight.

Preparations which are diluted prior to use comprise the active compound in concentrations of from 0.5-90 percent by weight, preferably from 1 to 50 percent by weight.

In general, it has proved advantageous to administer amounts of from approximately 0.5 to approximately 100 mg, preferably 1 to 50 mg, of active compound per kg of body weight per day to achieve effective results.

As regards solid preparations, mention may be made of powders, premixes and concentrates, granules, pellets, tablets, boluses, capsules, aerosols and inhalants, and shaped articles.

In a preferred embodiment, the parasite control according to the invention is carried out nonsystemically by means of dermal administration.

A further preferred embodiment which may be mentioned is the nonsystemic administration via shaped articles. Shaped articles are collars, medallions for collars, ear tags, bands for tying onto limbs or body parts, adhesive strips and adhesive films, strip films.

To achieve good effectiveness, it has generally proved advantageous to apply solid formulations according to the invention which release active compound quantities of from 10 to approximately 300 mg, preferably 20 to 200 mg, especially preferably 25 to 160 mg per kg body weight of the animal to be treated over at least three weeks.

Materials which are suitable for the preparation of the shaped articles are thermoplastic and flexible heat-curable polymers and elastomers and thermoplastic elastomers. Those which may be mentioned are polyvinyl resins, polyurethanes, polyacrylates, epoxy resins, cellulose, cellulose derivatives, polyamides and polyesters which are sufficiently compatible with the abovementioned active compound. The polymers must have sufficient strength and flexibility in order to avoid tearing or crumbling during shaping. They must be of sufficient durability in order to resist normal wear and tear. Moreover, the polymers must allow sufficient migration of the active compound to the surface of the shaped article.

The polyvinyl resins include polyvinyl halides such as polyvinyl chloride, polyvinyl chloride/vinyl acetate and polyvinyl fluoride; polyacrylate and polymethacrylate esters, such as polymethyl acrylate and polymethyl methacrylate; and polyvinylbenzenes such as polysyrene and polyvinyltoluene. Particular mention may be made of polyvinyl chloride.

Plasticizers which are suitable for the preparation of the polyvinyl-resin-based shaped articles are those which are conventionally used for plasticizing solid vinyl resins. The plasticizer to be used depends on the resin and its compatibility with the plasticizer. Examples of suitable plasticizers are esters of phosphoric acid, and also esters of phthalic acid, such as dimethyl phthalate and dioctyl phthalate, and esters of adipic acid such as diisobutyl adipate. Other esters, such as the esters of azelaic acid, maleic acid, ricinoleic acid, myristic acid, palmitic acid, oleic acid, sebacic acid, stearic acid and trimellitic acid, and complex linear polyesters, polymeric plasticizers and epoxidized soya oils, can also be used. The plasticizer quantity amounts to approximately 10 to 50% by weight, preferably approximately 20 to 45% by weight, of the total composition.

The shaped articles can additionally comprise other components such as stabilizers, lubricants, fillers and coloring matter without thereby modifying the fundamental characteristics of the composition. Suitable stabilizers are antioxidants and agents which protect the bands from ultraviolet rays and undesired degradation during processing such as extrusion. Some stabilizers, such as epoxidized soya oils, additionally serve as secondary plasticizers. Examples of lubricants which can be used are stearates, stearic acid and low-molecular-weight polyethylenes. These components can be used in a concentration of up to approximately 5% by weight of the total composition.

In the preparation of vinyl-based shaped articles, the various constituents are mixed by known methods and pressed into shapes by known extrusion or injection-molding processes.

The choice of the processing process for the preparation of the shaped articles in principle depends technically on the rheological properties of the material of the band and the shape of the desired band. The processing processes can be adjusted to suit the processing technology or the nature of the shaping. The processes can be classified in process technology according to the rheological states which they pass through. Accordingly, casting, pressing, injection-molding and application are possible for viscous materials for bands, and injection-molding, extruding, calendering, milling and, if appropriate, turning on edge are possible for elastoviscous polymers. Classified according to the nature of the shaping, the shaped articles according to the invention can be prepared by casting, dipping, pressing, injection-molding, extruding, calendering, embossing, bending, thermoforming and the like.

These processing processes are known and require no more detailed explanation. In principle, what has been said above by way of example for polyvinyl resins also applies to other polymers.

The polyurethanes which act as carrier material are prepared in a manner known per se by reacting polyisocyanates with higher-molecular-weight compounds which display at least two groups which are capable of reacting with isocyanates and, if appropriate, low-molecular-weight chain extenders and/or monofunctional chain terminators.

In this context, reference may be made to the following:
polyisocyanates which display isocyanurate groups as are described, for example, in US-PS 3 001 973, in DE-PS 1 022 789, 1 222 067 and 1 027 394 and in DE-OS 1 929 034 and 2 004 048; polyisocyanates which display urethane groups as are described, for example, in DE-PS 752 261 or in US-PS 3 394 164; polyisocyanates which display acylated urea groups as disclosed in DE-PS 1 230 778; polyisocyanates which display biuret groups as are described, for example, in DE-PS 1 101 394, in US-PS 3 124 605 and 3 201 372 and in GB-PS 889 050; polyisocyanates prepared by telomerization reactions as are described, for example, in US-PS 3 654 106; polyisocyanates which display ester groups as are mentioned, for example, in GB-PS 965 474 and 1 072 956, in US-PS 3 567 763 and in DE-PS 1 231 688; reaction products of the abovementioned isocyanates with acetals disclosed in DE-PS 1 072 385, and polyisocyanates comprising polymeric fatty acid residues, as described in US-PS 3 455 883.

It is also possible to employ distillation residues which display isocyanate groups and which are generated during the large-scale production of isocyanates, if appropriate dissolved in one or more of the abovementioned polyisocyanates. It is furthermore possible to employ any mixture of the abovementioned polyisocyanates.

Preferred polyisocyanates are generally the toluylene diisocyanates and the diphenylmethane diisocyanates.

Polyhydroxyl compounds which already comprise urethane or urea groups, and optionally modified, natural polyols, such as castor oil, carbohydrates or starch, polyester amides and polyamides include for example the predominantly linear condensates obtained from polybasic saturated and unsaturated carboxylic acids or their anhydrides and polyhydric saturated and unsaturated amino alcohols, diamines, polyamines and their mixtures, can be used for this purpose. Adducts of alkylene oxides with phenol/formaldehyde resins or else with urea/formaldehyde resins can be employed in accordance with the invention.

Representatives of these compounds are described for example in High Polymers, Vol. XVI, “Polyurethans, Chemistry and Technology”, written by Saunders-Frisch, Interscience Publishers, New York, London, Volume I, 1962, pages 32-42 and pages 44-54, and Volume I, 1964, pages 5-6 and 198-199, and in “Kunststoff-Handbuch” [Plastics Manual], Volume VII, Vieweg-Hochtlen, Carl-Hanser-Verlag, Munich, 1966, for example pages 45-71.

Naturally mixtures of the abovementioned compounds which have at least two hydrogen atoms which are capable of reacting with isocyanates and with a molecular weight of 400-10 000, for example mixtures of polyethers, can be employed.

When selecting the higher-molecular-weight polyol component used for the preparation of the polyurethane, it must be taken into consideration that the finished polyurethane must not be swellable in water. The use of an excess of polyhydroxyl compounds with ethylene oxide units (polyethylene glycol polyether or polyester with diethylene glycol or triethylene glycol as diol component) is therefore to be avoided.

Thermoplastic elastomers may be particularly emphasized for the preparation of the shaped articles. They are materials which comprise elastomeric phases in thermoplastically processable polymers, either incorporated as a physical mixture or chemically bound. Polymer blends in which the elastomeric phases are components of the polymeric structure can be classified. Owing to the construction of the thermoplastic elastomers, hard and soft zones are adjacent to one another. Here, the hard zones form a crystalline reticulate structure or a continuous phase whose interstices are filled in with elastomeric segments. Owing to this construction, these materials have rubber-like characteristics.

The thermoplastic elastomers can be classified into 5 main groups:
1. Copolyesters
2. Polyether block amides (PEBAS)
3. Thermoplastic polyurethanes (TPUs)
4. Thermoplastic polyolefins (TPOs)
5. Styrene block copolymers

Suitable copolyesters (segmented polyester elastomers) are constructed for example of a multiplicity of recurrent short-chain ester units and long-chain ester units which are linked via ester bonds, where the short-chain ester units amount to approximately 15-65% by weight of the copolyester and have the formula (II) 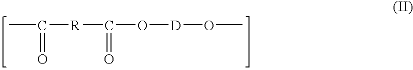
in which
R represents a divalent radical of a dicarboxylic acid which has a molecular weight of less than approximately 350,
D represents a divalent radical of an organic diol which has a molecular weight of less than approximately 250.

The long-chain ester units amount to approximately 35-85% by weight of the copolyester and have the formula (III) 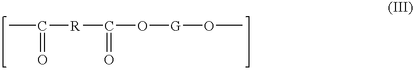
in which
R represents a divalent radical of a dicarboxylic acid which has a molecular weight of less than approximately 350,
G represents a divalent radical of a long-chain glycol which has an average molecular weight of approximately 350 to 6000.

Methods for the synthesis of such copolyesters are known from DOS 2 239 271, DOS 2 213 128, DOS 2 449 343 and US-P 3 023 192.

Suitable copolyesters are available for example under the trade names ®Hytrel from Du Pont, ®Pelpren from Toyobo®, Arnitel from Akzo, ®Ectel from Eastman Kodak and ®Riteflex from Hoechst.

Examples of suitable polyether block amides are those consisting of polymer chains which are composed of recurrent units corresponding to the formula (IV) 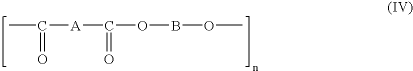
in which
A is the polyamide chain derived from a polyamide with 2 terminal carboxyl groups by the loss of the latter and
B is the polyoxyalkylene glycol chain derived from a polyoxyalkylene glycol with terminal OH groups by loss of the latter and
n is the number of the units which form the polymer chain.

Preferred end groups are OH groups or radicals of compounds which terminate the polymerization.

The dicarboxylic polyamides with the terminal carboxyl groups are obtained in a known manner, for example by polycondensation of one or more lactams and/or one or more amino acid, furthermore by polycondensation of a dicarboxylic acid with a diamine, in each case in the presence of an excess of an organic dicarboxylic acid, preferably with terminal carboxyl groups. During the polycondensation process, these carboxylic acids become component of the polyamide chain and associate in particular with the end of the latter, giving rise to an ∝-ω-dicarboxylic acid polyamide. The dicarboxylic acid furthermore acts as chain terminator, which is why it is employed in an excess.

The polyamide can be obtained starting from lactams and/or amino acids with a hydrocarbon chain consisting of 4-14 C atoms, such as, for example, caprolactam, oenantholactam, dodecalactam, undecanolactam, decanolactam, 11-aminoundecanoic or 12-aminododecanoic acid.

Examples which may be mentioned of polyamides as are obtained by subjecting a dicarboxylic acid to polycondensation with a diamine are the condensates of hexamethylenediamine with adipic acid, azelaic acid, sebacic acid and 1,12-dodecanedioic acid, and the condensates of nonamethylenediamine and adipic acid.

Suitable dicarboxylic acid used for the synthesis of the polyamide, that is to say firstly for attaching in each case one carboxyl group to each end of the polyamide chain and secondly as chain terminators, are those having 4-20 C atoms, in particular alkanedioic acids such as succinic acid, adipic acid, suberic acid, azelaic acid, sebacic acid, and undecanedioic acid or dodecanedioic acid, furthermore cycloaliphatic or aromatic dicarboxylic acids such as terephthalic acid or isophthalic acid or cyclohexane-1,4-dicarboxylic acid.

The polyoxyalkylene glycols which display terminal OH groups are unbranched or branched and display an alkylene radical having at least 2 C atoms. They are in particular polyoxyethylene glycol, polyoxypropylene glycol and polyoxytetramethylene glycol, and their copolymers.

The mean molecular weight of these OH-terminated polyoxyalkylene glycols can range within wide limits; it is advantageously between 100 and 6000, in particular between 200 and 3000.

The amount by weight of the polyoxyalkylene glycol based on the total weight of the polyalkylene glycol and dicarboxylic acid polyamide used for the preparation of the PEBA polymer amounts to 5-85%, preferably 10-50%.

Processes for the synthesis of such PEBA polymers are disclosed in FR-PS 7 418 913 (publication no. 2 273 021), DOS 2 802 989, DOS 2 837 687, DOS 2 523 991, EP-S 0 095-893, DOS 2 712 987 and DOS 2 716 004.

PEBA polymers which are preferably suitable are those which, in contrast to those described above, have random structures. Suitable and preferably suitable PEBA polymers are available for example under the trade names ®PEBAX from Atochem, ®Vestamid from Hüls AG, ®Grilamid from EMS-Chemie and ®Kellaflex from DSM.

The application can be both prophylactic and therapeutic.

In the case of collars, the active compound concentration is preferably 1 to 50%; in the case of medallions, pendants and ear tags preferably 2.5 to 35%, in the case of films, adhesive strips preferably 0.1 to 15%.

The novel formulations may additionally comprise further active compounds such as insecticides, attractants, sterilants, bactericides, acaricides, nematicides, fungicides and the like. Insecticides include, for example, phosphoric esters, carbamates, carboxylic esters, chlorinated hydrocarbons, phenylureas, substances produced by microorganisms, and the like.

The abovementioned active compounds can be present in the liquid, solid preparations and shaped articles as a mixture with synergists or other active compounds. The active compounds include insecticides such as phosphorus-containing compounds, i.e. phosphoric ester or phosphonic ester, natural or synthetic pyrethroids, carbamates, amidines, juvenile hormones and synthetic juvenoid active compounds.

The phosphoric esters or phosphoric esters include:
O-ethyl O-(8-quinolyl)phenylthiophosphate (Quintiofos),
O,O-diethyl O-(3-chloro-4-methyl-7-coumarinyl)thiophosphate (Coumaphos),
O,O-diethyl O-phenyl-glyoxylonitrile oxime thiophosphate (Phoxim),
O,O-diethyl O-cyanochlorbenzaidoxime thiophosphate (Chlorphoxim),
O,O-diethyl O-(4-bromo-2,5-dichlorophenyl)-phosphorothionate (Bromophos-ethyl),
O,O,O′,O′-tetraethyl S,S′-methylene di(phosphorodithionate) (Ethion),
2,3-p-dioxanedithiol S,S-bis(O,O-diethylphosphorodithionate,
2-chioro-1(2,4-dichlorophenyl)vinyl diethyl phosphate (Chlorfenvinphos),
O,O-dimethyl O-(3-methyl-4-methylthiophenyl) thionophosphate (Fenthion).

The carbamates include:
2-isopropoxyphenyl methylcarbamate (Propoxur),
1-naphthyl N-methylcarbamate (carbaryl).

The synthetic pyrethroids include compounds of the formula I 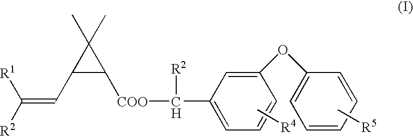
in which
R¹ and R² represent halogen, optionally halogen-substituted alkyl, optionally halogen-substituted phenyl,
R³ represents hydrogen or CN,
R⁴ represents hydrogen or halogen,
R⁵ represents hydrogen or halogen.

Preferred synthetic pyrethroids of the formula I are those in which
R¹ represents halogen, in particular fluorine, chlorine or bromine,
R² represents halogen, in particular fluorine, chlorine, bromine, trihalomethyl, phenyl, chlorophenyl,
R³ represents hydrogen or CN,
R⁴ represents hydrogen or fluorine,
R⁵ represents hydrogen.

Especially preferred synthetic pyrethroids of the formula I are those in which
R¹ is chlorine,
R² is chlorine, trifluoromethyl, p-chlorophenyl,
R³ represents CN,
R⁴ represents hydrogen or fluorine,
R⁵ represents hydrogen.

Particular mention may be made of compounds of formula I in which
R¹ represents chlorine,
R² represents chlorine or p-chlorophenyl,
R³ represents CN,
R⁴ represents fluorine in 4-position,
R⁵ represents hydrogen.

Compounds which may be mentioned individually are:
(∝-cyano-4-fluoro-3-phenoxy)benzyl 3-[2-(4-chlorophenyl)-2-chlorovinyl]-2,2-dimethylcyclopropanecarboxylate (Flumethrin),
∝-cyano-(4-fluoro-3-phenoxy)benzyl 2,2-dimethyl-3-(2,2-dichlorovinyl)-cyclopropanecarboxylate (Cyfluthrin) and its enantiomers and stereomers,
∝-cyano-3-phenoxybenzyl (±)-cis,trans-3-(2,2-dibromovinyl)-2,2-dimethylcyclopropanecarboxylate (Deltamethrin),
∝-cyano-3-phenoxybenzyl 2,2-dimethyl-3-(2,2-dichlorovinyl)cyclopropanecarboxylate (Cypermethrin),
3-phenoxybenzyl (±)-cis,trans-3-(2,2-dichlorovinyl)-2,2-dimethylcyclopropanecarboxylate (Permethrin),
∝-cyano-3-phenoxybenzyl ∝-(p-Cl-phenyl)isovalerate (Fenvalerate),
2-cyano-3-phenoxybenzyl 2-(2-chloro-∝,∝,∝-trifluoro-p-toluidino)-3-methylbutyrate (Fluvalinate).

The amidines include:
3-methyl-2-[2,4-dimethylphenylimino]thiazoline,
2-(4-chloro-2-methylphenylimino)-3-methylthiazolidine,
2-(4-chloro-2-methylphenylimino)-3-(isobutyl-1-enyl)thiazolidine,
1,5-bis(2,4-dimethylphenyl)-3-methyl-1,3,5-triazapenta-1,4-diene (Amitraz).

The juvenile hormones or juvenile hormone analogs include substituted diaryl ethers, benzoylureas and triazine derivatives. The juvenile hormones and juvenile hormone analogs include in particular compounds of the following formulae:

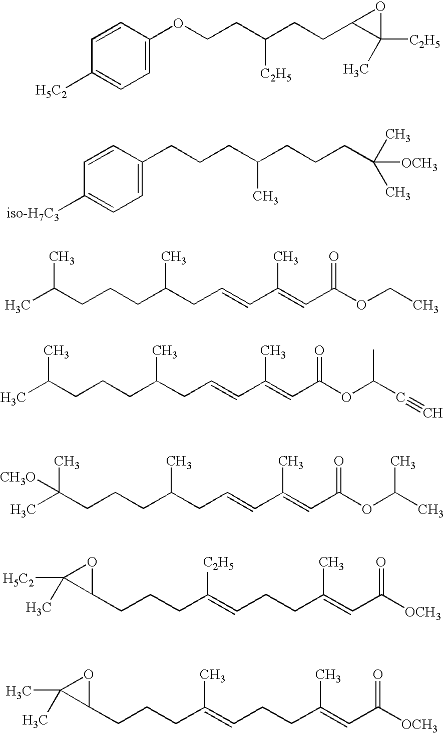

The substituted diaryl ethers include in particular substituted alkoxydiphenyl ethers or alkoxydiphenylmethanes of the general formula I 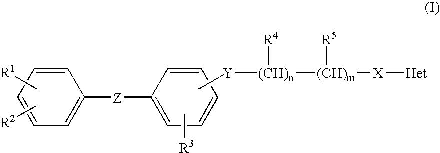
where
R¹ represents hydrogen, halogen, alkyl, alkoxy, alkylthio, haloalkyl, haloalkoxy, haloalkylthio, dioxyalkylene, dioxyhaloalkylene, CN, NO₂, alkenyl, alkynyl, alkoxyalkyl, alkoxyalkoxy, hydroxyalkoxy,
R² represents the radicals given for R¹,
R³ represents the radicals given for R¹,
R⁴ represents hydrogen, alkyl, haloalkyl or halogen,
R⁵ represents the radicals given for R⁴,
Het represents optionally substituted heteroaryl which is bonded to the remainder of the radical via other than the hetero atom,
X, Y independently of one another represent —O—, —S—,
Z represents —O—, —S—, —CH₂—, —CHCH₃—, —C(CH₃)₂—,
m and n independently of one another represent 0, 1, 2, 3, but their total is 2 or greater than 2.

Especially preferred compounds of the formula I are those
in which
R¹ represents hydrogen, methyl, trifluoromethyl, methoxy, trifluoromethoxy, chlorine, fluorine,
R² represents hydrogen,
R³ represents hydrogen, fluorine, chlorine, methyl,
R⁴ represents hydrogen or methyl,
R⁵ represents methyl, ethyl, fluoromethyl or hydrogen,
Het represents pyridyl or pyridazinyl which are optionally substituted by fluorine, chlorine, methyl, NO₂, methoxy, methylmercapto,
X represents O,
Y represents O,
Z represents O, CH₂ or —(CH₃)₂—,
m represents 1,
n represents 1.

The following compounds may be mentioned individually:

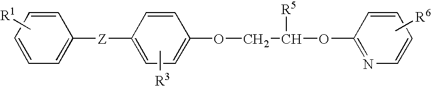

| R¹ | R³ | R⁵ | R⁶ | Z |
|---|---|---|---|---|
| H | H | CH₃ | H | O |
| H | H | CH₃ | 2-Cl | O |
| 5-F | H | CH₃ | H | O |
| H | H | CF₃ | H | O |
| H | H | C₂H₅ | H | O |
| H | H | H | H | O |
| H | H | CH₃ | H | CH₂ |
| H | H | CH₃ | H | C(CH₃)₂ |

The benzoylureas include compounds of the formula (V): 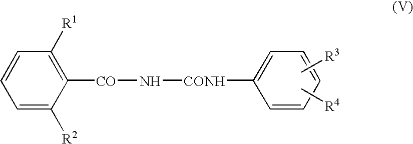
where
R¹ represents halogen,
R² represents hydrogen or halogen,
R³ represents hydrogen, halogen or C₁₋₄-alkyl,
R⁴ represents halogen, or represents 1-5-halo-C₁₋₄-alkyl, C₁₋₄-alkoxy, 1-5-halo-C₁₋₄-alkoxy, C₁₋₄-alkylthio, 1-5-halo-C₁₋₄-alkylthio, phenoxy or pyridyloxy, all of which can optionally be substituted by halogen, C₁₋₄-alkyl, 1-5-halo-C₁₋₄-alkyl, C₋₄-alkoxy, 1-5-halo-C₁₋₄-alkoxy, C₁₋₄-alkylthio, 1-5-halo-C₁-C₄-alkylthio.

The following may be mentioned in particular:

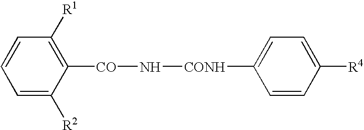

| R¹ | R² | R⁴ |
|---|---|---|
| H | Cl | CF₃ |
| Cl | Cl | CF₃ |
| F | F | CF₃ |
| H | F | CF₃ |
| H | Cl | SCF₃ |
| F | F | SCF₃ |
| H | F | SCF₃ |
| H | Cl | OCF₃ |
| F | F | OCF₃ |
| H | F | OCF₃ |
| F | F | 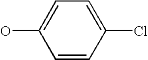 |
| F | F | 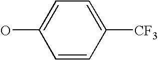 |
| F | F | 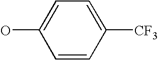 |

Co-active-compound concentrations and synergist concentrations can be varied within wide limits from in each case 0.1 to 25% by weight, preferably 1 to 10% by weight.

Others which are of interest with regard to the activity against parasitic protozoans are: mixtures or combinations of the compounds of the formula (I) with a polyether antibiotic or a synthetic coccidiostat.

Synthetic coccidiostats or polyether antibiotics for use in the mixtures according to the invention which are preferably mentioned are:
amprolium, in some cases in combination with folic acid antagonists
robenidin
toltrazuril
monensin
salinomycin
maduramicin
lasalocid
narasin
semduramicin.

Preferred among this list are monensin, salinomycin and maduramicin. The mixture with maduramicin is particularly emphasized.

Ready-to-use preparations comprise the active compounds in concentrations of from 10 ppm to 20 percent by weight, preferably from 0.1 to 10 percent by weight.

Preparations which are diluted prior to use comprise the active compound in concentrations of from 0.5 to 90 percent by weight, preferably from 1 to 50 percent by weight.

To achieve effective results, it has generally proved advantageous to administer amounts of from approximately 0.5 to approximately 50 mg, preferably from 1 to 20 mg, of active compound per kg of body weight per day.

The active compounds are present, in the mixture with other coccidiostats or polyether antibiotics, in a ratio of 1 to 0.1-10 up to 1 to 1-10. A ratio of 1 to 5 is preferred.

The active compounds can also be administered together with the feed or the drinking water of the animals.

Feeding stuffs and foodstuffs comprise 0.01 to 250 ppm, preferably 0.5 to 100 ppm, of the active compound in combination with a suitable edible material.

Such a feeding stuff and foodstuff can be used both for therapeutic purposes and for prophylactic purposes.

Such a feeding stuff or foodstuff is produced by mixing a concentrate or a premix which comprises 0.5 to 30%, preferably 1 to 20% by weight, of an active. compound in admixture with an edible organic or inorganic carrier, with conventional feeding stuffs. Edible carriers are, for example, corn meal or corn and soybean meal or mineral salts which preferably comprise a small amount of an edible antidust oil, for example corn oil or soya oil. The resulting premix can then be added to the complete feeding stuff before the latter is fed to the animals.

An example which may be mentioned is the use in coccidiosis:

For the therapy and prophylaxis of, for example, coccidiosis in poultry, in particular in chickens, ducks, geese and turkeys, 0.1 to 100 ppm, preferably 0.5 to 100 ppm, of an active compound is mixed with a suitable edible material, for example a nutritious feeding stuff. If desired, these amounts can be increased, in particular when the active compound is well tolerated by the recipient. The administration via the drinking water can be carried out analogously.

For the treatment of individual animals, for example in the case of the treatment of coccidiosis in mammals or toxoplasmosis, it is preferred to administer active compound quantities of from 0.5 to 100 mg/kg body weight per day to achieve the desired results. Nevertheless, it may occasionally be necessary to deviate from the abovementioned amounts, in particular as a function of the body weight of the subject or of the route of application, but also owing to the genus of the animal and its individual reaction to the active compound or the type of formulation and the time or interval at which it is administered. Thus, in some cases, less than the abovementioned minimum amount will be sufficient while the abovementioned upper limit will have to be exceeded in other cases. When administering substantial amounts, it may be expedient to split them into a plurality of single doses over the day.

The activity of the compounds according to the invention can be confirmed for example in cage experiments using the following experimental set-up, in which the animals are treated with the individual components in question and with the mixtures of the individual components.

An active-compound-comprising feed is prepared in such a way that the required amount of active compound is mixed thoroughly with a nutritionally balanced animal feed, for example with the chick feed detailed hereinbelow.

If a concentrate or a premix, which is eventually to be diluted in the feed to the values mentioned in the experiment, is to be prepared, generally approximately 1 to 30%, preferably approximately 10 to 20% by weight, of active compound are mixed with an edible organic or inorganic carrier, for example corn and soya meal or mineral salts which comprise a small amount of an edible anti-dust oil, fir example corn oil or soya oil. The resulting premix can then be added to the complete poultry feed before it is fed to the animals.

An example of the use of the substances according to the invention in the poultry feed is the following composition.
52.00% of coarse feed cereal meal, viz: 40% maize, 12% wheat
17.00% of extracted soybean meal
5.00% of maize gluten feed
5.00% of feed wheat meal
3.00% of fish meal
3.00% of mineral blend
3.00% of alfalfa meal
2.50% of vitamin premix
2.00% of comminuted wheat germ
2.00% of soya oil
2.00% of meat and bone meal.
1.50% of powdered whey
1.00% of molasses
1.00% of brewers' yeast bound to spent brewers' grain
100.00%

Such a feed comprises 18% crude protein, 5% crude fiber, 1% Ca, 0.7% P, and per kg, 1200 I.U. vitamin A, 1200 I.U. vitamin D3, 10 mg vitamin E, 20 mg zinc bacitracin.

The active compound is mixed with this feed in amounts of from, for example, 1 to 20 ppm, (w/w). Suitable dosage rates of the active compound are, for example, 1 ppm; 2.5 ppm; 5 ppm (in each case shown as parts by weight “(w/w)”).

In the following examples, the compounds A and B are employed as active compounds.

### EXAMPLES

### Example 1

Test with resistant one-host cattle ticks/SP-resistant Parkhurst strain Injection method
Test animals: adult engorged Boophilus micorplus females (strain Parkhurst SP-resistant)
Solvent: dimethyl sulfoxide
   20 mg of active compound are dissolved in one ml of dimethyl sulfoxide, and lower concentrations are prepared by dilution with the same solvent.

The test is carried out in quintuplicate. 1 μl of the solutions is injected into the abdomen, and the animals are transferred into dishes and stored in a room with a controlled environment. The activity check is carried out after 7 days for the deposition of fertile eggs. Eggs whose fertility is not externally visible are stored in glass tubes in controlled-environment cabinets until the larvae hatch after approximately 24 days. 100% activity means that no tick has deposited fertile eggs.

In this test, a good activity is shown, for example, by the following compounds of the preparation examples:
compound A, at a rate of 100 μg, showed 100% activity (inhibition of the deposition of fertile eggs)
compound B, at a rate of 20 μg, showed 100% activity (inhibition of the deposition of fertile eggs)

### Example 2

Test for the development of Musca domestica larvae on cattle dung following oral treatment of the animal with active-compound-comprising formulation (feed-through test)

Cattle 300 kg in weight are fed on three consecutive days with in each case 3 g of active compound in a capsule formulation. Dung samples of treated animals are populated with Musca domestica first instars, and the development into adult flies was monitored in comparison with the development of dung samples of an untreated control. Those substances which reliably prevent the development of adults over a period of four weeks are assessed as active.

A 50% activity up to day 3 after the treatment, followed by a 100% long-term activity, was shown by compound A.

1. The use of phenylketoenol derivatives of the general formula (I) 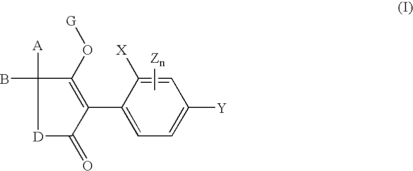
in which
X represents alkyl, halogen, alkoxy or haloalkyl,
Y represents hydrogen, alkyl, halogen, alkoxy, haloalkyl,
Z represents alkyl, halogen alkoxy,
n represents a number from 0 to 3 or where the radicals X and Z together with the phenyl radical to which they are bonded form the naphthalene radical of the formula 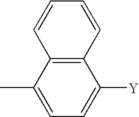
in which Y has the abovementioned meaning,
G represents hydrogen (a) or the groups 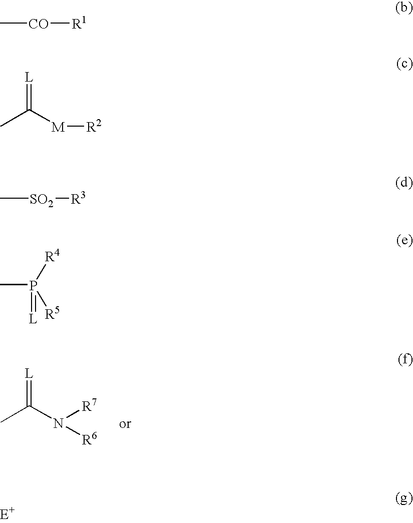
A and B can be identical or different and represent hydrogen, optionally halogen-substituted alkyl, alkenyl, alkynyl, alkoxyalkyl, alkylthioalkyl, or represent cycloalkyl which is optionally interrupted by hetero atoms, or represent aryl, aralkyl or hetaryl, each of which is optionally substituted by halogen, alkyl, haloalkyl, alkoxy, haloalkoxy, nitro,
or where
A and B together with the carbon atom to which they are bonded form a saturated or unsaturated cycle which is optionally interrupted by hetero atoms and optionally substituted,
D represents oxygen, sulfur or —NH—,
E⁺ represents a metal ion equivalent or an ammonium ion,
L and M represents oxygen and/or sulfur,
R¹ represents optionally halogen-substituted alkyl, alkenyl, alkoxyalkyl, alkylthioalkyl, polyalkoxyalkyl or cycloalkyl, which can be interrupted by hetero atoms, or represents optionally substituted phenyl, optionally substituted phenylalkyl, substituted hetaryl, substituted phenoxyalkyl or substituted hetaryloxyalkyl and
R² represents optionally halogen-substituted alkyl, alkenyl, alkoxyalkyl, polyalkoxyalkyl, or optionally substituted phenyl or benzyl,
R³, R⁴ and R⁵ independently of one another represent optionally halogen-substituted alkyl, alkoxy, alkylamino, dialkylamino, alkylthio, alkenylthio, alkynylthio, cycloalkylthio and optionally substituted phenyl, phenoxy or phenylthio,
R⁶ and R⁷ independently of one another represent hydrogen, optionally halogen-substituted alkyl, alkenyl, alkoxy, alkoxyalkyl, or represent optionally substituted phenyl, or represent optionally substituted benzyl,
or where R⁶ and R⁷ together represent an alkylene radical which is optionally interrupted by oxygen,
with the exception of the following compounds:
3-(2-methoxyphenyl)-4-hydoxy-Δ³-dihydrofuran-2-one,
3-(2-chlorophenyl)-4-hydoxy-Δ³-dihydrofuran-2-one,
3-(2-methoxyphenyl)-4-hydoxy-Δ³-dihydrofuran-2-one,
3-(2-fluorophenyl)-4-hydoxy-Δ³-dihydrofuran-2-one,
and the enantiomerically pure forms of compounds of the formula (I),
for the preparation of medicaments for controlling parasites in animals and in their environment.

2. A method for controlling parasites in animals and in their environment, in which a suitable amount of active compound of the formula (I) as claimed in claim 1 is applied to the animals.
